(19) United States
(12) Patent Application Publication
(10) Pub. No.: US 2023/0059940 A1
(43) Pub. Date: Feb. 23, 2023

(54) SYSTEMS AND METHODS FOR APPLICATION HEALTH BASED NETWORK TRAFFIC ROUTING IN A GEOGRAPHICALLY DISTRIBUTED CLOUD SERVICE

(71) Applicant: Citrix Systems, Inc., Fort Lauderdale, FL (US)

(72) Inventors: Sachin Mandya Shankar, Fremont, CA (US); Hrushikesh Shrinivas Paralikar, Milpitas, CA (US)

(73) Assignee: Citrix Systems, Inc., Fort Lauderdale, FL (US)

(21) Appl. No.: 17/405,655

(22) Filed: Aug. 18, 2021

(51) Int. Cl. H04L 29/08

(52) U.S. Cl. CPC H04L 67/1008; H04L 67/1029

(57) ABSTRACT

Described herein are systems and methods for application health based network traffic routing in a geographically distributed cloud service. The domain name system (DNS) resolver can receive, from a service executing on one or more servers hosting a resource, a performance score of the resource. The performance score can be computed from a plurality of metrics determined from a performance monitoring service executing on the one or more servers in communication with the resource. The plurality of metrics can include a first set of performance metrics based on simulated client requests and a second set of performance metrics based on an application's own performance factors. The DNS resolver can receive, from a client, a request to resolve a DNS request. The DNS resolver can transmit, by the DNS resolver, a response to the request identifying the one or more servers selected based on the performance score of the resource.

### FIELD OF THE DISCLOSURE

The present application generally relates to routing network traffic, including but not limited to systems and methods for application health based network traffic routing in a geographically distributed cloud service.

### BACKGROUND

Clients or processing engines can use resources hosted on servers, but load balancing the usage across the servers is difficult.

### SUMMARY

This Summary is provided to introduce a selection of concepts in a simplified form that is further described below in the Detailed Description. This Summary is not intended to identify key features or essential features, nor is it intended to limit the scope of the claims included herewith.

Described herein are systems and methods for application health based network traffic routing in a geographically distributed cloud service. In particular, the systems and methods relate to computing application health scores to route global traffic in a geographically distributed cloud service. The systems and methods described herein further relate to computing application driven health scores to modify traffic routing decisions in a geographically distributed cloud service.

The systems and methods can facilitate geographically distributed cloud services and applications to define exact factors that influence network performance. A template file can include declarations of the factors in the form of time-series based database metrics. Components and algorithms that measure the cloud service's health score can use the template file to modify the global routing decisions of the traffic bound for the cloud service.

The embodiments described herein enable cloud services to declare parameters that are important to their network instead of having to rely solely on generic network performance data. The application can execute the algorithm based on the time-series database metrics to calculate health scores with a high degree of accuracy, which can provide a declarative configuration for individual services to configure health measurements. For example, the systems and methods described herein can relate to a delivery network architecture, such as CITRIX GATEWAY.

The systems and methods described herein can provide cloud services and a template to define custom metrics that best identifies the health of the application. The template can be included inside a point of presence (PoP)-Health-Measurement component/service (PHS) deployed inside public Cloud PoPs in which the application executes. The PHS can continuously monitor services defined in the template and influence the DNS selection for the application via fusion feed (custom data) integration on Global Traffic Load Balancing systems. The template file can be a YAML file that defines cloud PoP specific metadata and a list of service objects that are monitored by the PHS.

Each service object can define a list of metric objects that identify the individual application health. A metrics aggregator, such as Prometheus—an Open-Source Cloud Native project—can be the monitoring tool that measures application health. Applications can generate their metrics in a format of the metrics aggregator, such as a Prometheus format (time-series based), and expose the metrics on a representational state transfer architectural style (REST) endpoint.

The metrics aggregator can scrape health metrics based on the scrape targets for the applications. Rules and alerts can define how to pre-compute health related scores and trigger alerts when the metrics satisfy thresholds. The PHS can receive the alerts via an alert manager of the metrics aggregator, which can group alerts of similar kind.

Each metric object can identify metric specific metadata such as metric name, metric type, and score metadata. The metric specific metadata can include a metric name that identifies the name of the application metric as exported to the metrics aggregator. The metric object can include a metric type, such as performance type, service level indicator (SLI) type, or synthetic type or some combination of the performance type, service level indicator (SLI) type, and synthetic type. The performance type can identify a measurement of the underlying server performance such as packet interface rate, CPU usage, or File I/O operations rate. The SLI type can identify a service level indication of specific endpoints measured by instrumenting APIs or dependency failure rates. For example, 95% of the login endpoint requests in any five-minute interval must be serviced in less than 300 ms. The synthetic type can identify a measurement of network latency of endpoints of an application as viewed by a close proximity client. For example, the measurement can be a TCP round trip time or TCP handshake failure rate. The score metadata can identify the algorithm that the PHS can use to measure the health score for the metric and a percentage weight of the resulting score in the overall health of the application.

The PHS can calculate a score. The calculated score for a given metric can depict outliers or anomalies in the performance of the application or the application itself. The score can be a percentage value between 0-100, wherein a large value indicates deteriorating health. The PHS can use a use a native query language of the metrics aggregator, such as PromQL for Prometheus, to retrieve metrics from the metrics aggregator to then compute the health score for each metric. The metrics aggregator can store the metrics as time series such as streams of timestamped values. These streams can identify a collection of the metric's observed values over time. The streams can be a counter, a gauge, or a compound type called a histogram.

Depending on the metric that is being observed, the score calculation for a metric can be classified into at least a fixed score calculation or a variable score calculation. The fixed score calculation can include comparing the current value of the metric with a fixed threshold. The fixed threshold can indicate an upper or lower bound of the metric. For example, the CPU usage metric can represent a percentage value of the server's CPU consumption, and an upper bound of 95% can be a threshold for the metric relating to the CPU consumption. For values closer to or exceeding the upper bound, the PHS can steer network traffic away from this PoP.

Variable score calculation can be performed when the upper or lower bounds for the metric does not have a fixed threshold value. For example, a metric such as a TCP Round Trip Time might not have upper or lower bounds. In particular, adding fixed thresholds to detect anomalies in this example may not be accurate because the round trip time (RTT) may vary depending on the application's load over time and the ideal threshold would not be a fixed value. In such cases, the PHS can perform score calculations that compute the z-score of the current metric value to determine its health. Z-scores indicate the standard deviation (σ) of the current value from its weekly or monthly mean value. A z-score that is greater than 2σ implies that a metric value deviates by more than 95% from its mean value.

After calculating the individual scores for the metrics of the service, the PHS can compute the overall health score by calculating a weighted sum of each score. The PHS can use weights provided by the application itself in the template file.

The systems and methods described herein can influence DNS decisions made by a DNS resolver. For example, the systems and methods herein can use an intelligent network traffic manager such as the CITRIX ITM as the DNS resolver. The DNS resolver can be configured to receive data feeds from the PHS for the PoPs. The feed payload can include the computed health score for the cloud service. At the time of DNS resolution, the DNS resolver can consider this data to make its DNS decisions. If the health score from the PHS indicates that the PoP is relatively unhealthy, this information would influence the observed RTT value for a given cloud PoP. The PHS can de-prioritize the unhealthy PoP based on a higher RTT. If the PHS identifies that the PoP is unable to serve any more traffic, the DNS resolver can exclude this PoP from the DNS decisions until it is enabled by the PHS after the health is restored. This approach can be known as PoP rotation that includes or excludes a PoP in the DNS response sent to the client.

In one aspect, this disclosure is directed to a method. The method includes receiving, by a domain name system (DNS) resolver from a service executing on one or more servers hosting a resource, a performance score of the resource. The method includes receiving, by the DNS resolver, from a client, a request to resolve a DNS request. The method includes transmitting, by the DNS resolver, a response to the request identifying the one or more servers selected based on the performance score of the resource.

In some embodiments, the performance score of the resource is computed from a plurality of metrics determined from a performance monitoring service executing on the one or more servers in communication with the resource. In some embodiments, the plurality of metrics comprise a first set of performance metrics based on simulated client requests and a second set of performance metrics based on live client requests. In some embodiments, the performance score is based on a first weight assigned to the first set of performance metrics and a second weight assigned to the second set of performance metrics. In some embodiments, the plurality of metrics comprise at least one fixed metric and at least one variable metric. In some embodiments, the performance score is based on a first weight assigned to the at least one fixed metric and a second weight assigned to the at least one variable metric.

In some embodiments, the method further comprises determining, by the DNS resolver, a metric of the one or more servers based on the health score. In some embodiments, the method further comprises selecting, by the DNS resolver, the one or more servers based on the determined metric. In some embodiments, the metric comprises a round trip time corresponding to the DNS resolver and the one or more servers.

In some embodiments, the one or more servers are one or more first servers. In some embodiments, the method further comprises receiving, by the DNS resolver, a status of one or more second servers hosting the resource. In some embodiments, the method further comprises restricting, by the DNS resolver, selection of the one or more second servers based on the status of the one or more second servers. In some embodiments, the status is a first status. In some embodiments, the method further comprises receiving, by the DNS resolver, subsequent to the first status, a second status of one or more second servers hosting the resource. In some embodiments, the method further comprises enabling, by the DNS resolver, selection of the one or more second servers based on the second status of the one or more second servers.

In some embodiments, the service is a first service, the one or more servers is one or more first servers and the performance score is a first performance score. In some embodiments, the method further comprises receiving, by the domain name system (DNS) resolver from a second service executing on one or more second servers hosting the resource, a second health score of the resource. In some embodiments, transmitting, by the DNS resolver, the response to the request identifying the one or more servers includes transmitting, by the DNS resolver, the response to the request identifying the one or more first servers selected based on the first health score of the resource and the second health score of the resource. In some embodiments, the method further comprises configuring the resource to provide metrics used by the health service to generate the health score.

In another aspect, this disclosure is directed to a system. The system includes a domain name system (DNS) resolver. The DNS resolver is configured to receive, from a service executing on one or more servers hosting a resource, a performance score of the resource. The DNS resolver is configured to receive, from a client, a request to resolve a DNS request. The DNS resolver is configured to transmit a response to the request identifying the one or more servers selected based on the performance score of the resource.

In some embodiments, the performance score is computed from a plurality of metrics determined from a performance monitoring service executing on the one or more servers in communication with the resource. In some embodiments, the plurality of metrics comprise a first set of performance metrics based on simulated client requests and a second set of performance metrics based on live client requests. In some embodiments, the performance score is based on a first weight assigned to the first set of performance metrics and a second weight assigned to the second set of performance metrics.

In some embodiments, the plurality of metrics comprise at least one fixed metric and at least one variable metric. In some embodiments, the performance score is based on a first weight assigned to the at least one fixed metric and a second weight assigned to the at least one variable metric.

In some embodiments, the DNS resolver is further configured to determine a metric of the one or more servers based on the health score. In some embodiments, the DNS resolver is further configured to select the one or more servers based on the determined metric. In some embodiments, the metric comprises a round trip time corresponding to the DNS resolver and the one or more servers.

In some embodiments, the one or more servers are one or more first servers. In some embodiments, the DNS resolver is further configured to receive a status of one or more second servers hosting the resource. In some embodiments, the DNS resolver is further configured to restrict selection of the one or more second servers based on the status of the one or more second servers. In some embodiments, the status is a first status. In some embodiments, the DNS resolver is further configured to receive, subsequent to the first status, a second status of one or more second servers hosting the resource. In some embodiments, the DNS resolver is further configured to enable selection of the one or more second servers based on the second status of the one or more second servers.

In some embodiments, the service is a first service, the one or more servers is one or more first servers and the performance score is a first performance score. In some embodiments, the DNS resolver is further configured to receive, from a second service executing on one or more second servers hosting the resource, a second health score of the resource. In some embodiments, transmitting the response to the request identifying the one or more servers includes transmitting the response to the request identifying the one or more first servers selected based on the first health score of the resource and the second health score of the resource.

In another aspect, this disclosure is directed to a non-transitory computer-readable medium storing instructions that, when executed by one or more processors, cause the one or more processors to receive, from a service executing on one or more servers hosting a resource, a performance score of the resource. The one or more processors can receive, from a client, a request to resolve a domain name system (DNS) request. The one or more processors can transmit a response to the request identifying the one or more servers selected based on the performance score of the resource.

### BRIEF DESCRIPTION OF THE DRAWING FIGURES

Objects, aspects, features, and advantages of embodiments disclosed herein will become fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, with emphasis instead being placed upon illustrating embodiments, principles, and concepts. The drawings are not intended to limit the scope of the claims included herewith.

FIG. 1A is a block diagram of a network computing system, in accordance with one or more embodiments;

FIG. 1B is a block diagram of a network computing system for delivering a computing environment from a server to a client via an appliance, in accordance with one or more embodiments;

FIG. 1C is a block diagram of a computing device, in accordance with one or more embodiments;

FIG. 2 is a block diagram of an appliance for processing communications between a client and a server, in accordance with one or more embodiments;

FIG. 3 is a block diagram of a virtualization environment, in accordance with one or more embodiments;

FIG. 4 is a block diagram of a cluster system, in accordance with one or more embodiments;

FIG. 5 is a block diagram of a system for application health based network traffic routing in a geographically distributed cloud service, in accordance with one or more embodiments;

FIG. 6 is a diagram of a workflow of a metrics service and an alert service for application monitoring based network traffic routing in a geographically distributed cloud service, in accordance with one or more embodiments;

FIG. 7 is a diagram of a workflow of a simulation service and a scoring service for application health score computation in a geographically distributed cloud service, in accordance with one or more embodiments;

FIG. 8 is a diagram of a workflow of a DNS resolver for application health based network traffic routing in a geographically distributed cloud service, in accordance with one or more embodiments; and

FIG. 9 is a flow diagram of a method for application health based network traffic routing in a geographically distributed cloud service, in accordance with one or more embodiments.

### DETAILED DESCRIPTION

Network architectures can include globally replicated cloud services to increase the availability of applications. Such cloud services can use various mechanisms to monitor the service and detect availability. The DNS selection logic can include factors based on network performance, health data, or other basic health monitoring done by the services internally, such as “pings” to identify network health status.

Moreover, networks fail to include infrastructure for an application to define its own performance factors rather than just the network performance from external sources. For example, a data intensive application may want to include performance metrics related to its CPU usage or File IO for the DNS selection logic to analyze. In another example, a distributed application that depends on several other internal services may want to include SLI (service level indicator) data that is specific to certain endpoints.

However, applications are highly dynamic and network performance alone cannot provide an accurate measurement of an application's performance or health. Therefore, global traffic routing using network performance data for these applications is not optimal.

The systems and methods described herein relate to using various types of health metrics to monitor the health of the application. For example, the health metrics can include connection metrics generated with synthetic monitoring, system health metrics like CPU usage, packet rates, memory usage, and other SLI metrics that measure the availability of the multitenant service. The systems and methods described herein describe how this continuous health monitoring can facilitate adjusting the routing selections. For example, the selection logic can prevent network outages by assigning lower precedence to relatively unhealthy servers because of their load or by removing servers until they regain their health status.

For purposes of reading the description of the various embodiments below, the following descriptions of the sections of the specification and their respective contents may be helpful:

Section A describes a network environment and computing environment which may be useful for practicing embodiments described herein;

Section B describes embodiments of systems and methods for delivering a computing environment to a remote user;

Section C describes embodiments of systems and methods for providing a clustered appliance architecture environment;

Section D describes embodiments of systems and methods for providing a clustered appliance architecture environment; and

Section E describes embodiments of systems and methods for application health based network traffic routing in a geographically distributed cloud service.

Section F describes various example embodiments of the systems and methods described herein.

### A. Network and Computing Environment

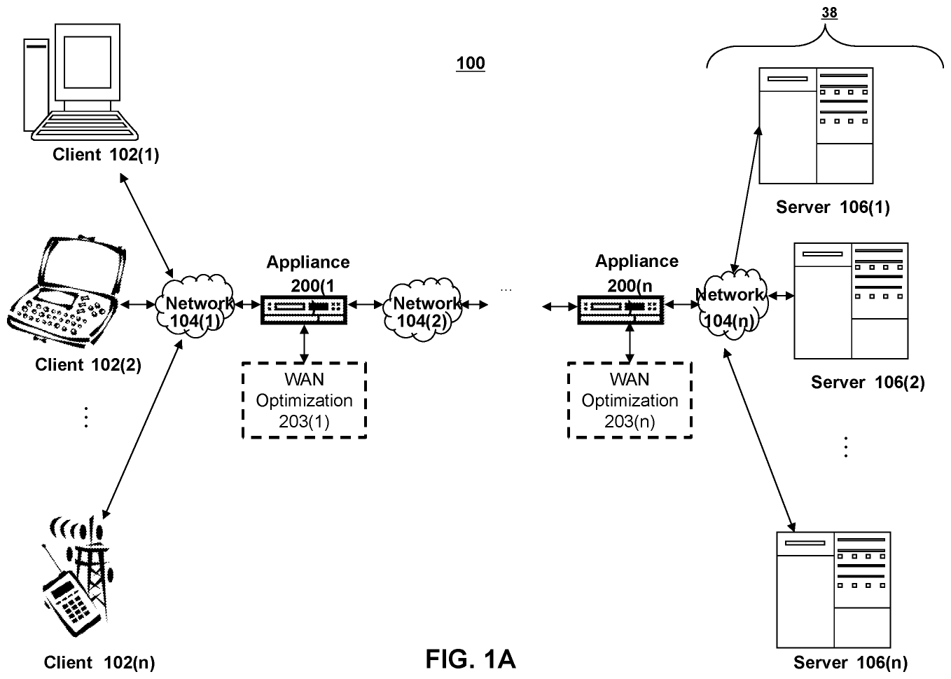

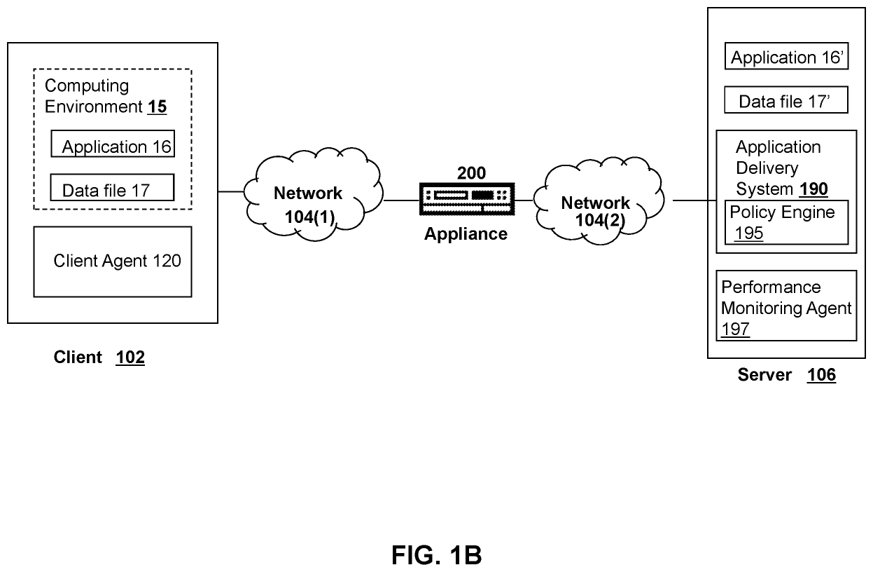

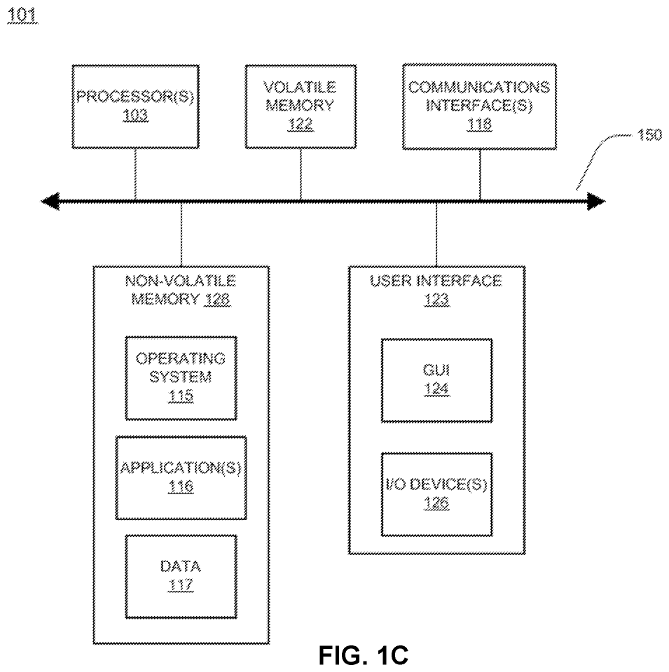

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104(n) (generally referred to as network(s) 104). In some embodiments, a client 102 may communicate with a server 106 via one or more appliances 200(1)-200(n) (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In another embodiment, appliance 200 may be implemented as a network device such as Citrix networking (formerly NetScaler®) products sold by Citrix Systems, Inc., of Fort Lauderdale, Fla.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In one embodiment, server farm 38 executes one or more applications on behalf of one or more of clients 102 (e.g., as an application server), although other uses are possible, such as a file server, gateway server, proxy server, or other similar server. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application 16 that accesses, processes, or uses a data file 17. Computing environment 15, application 16 and/or data file 17 may be delivered via appliance 200 and/or the server 106.

Appliance 200 may accelerate delivery of all or a portion of computing environment 15 to a client 102, for example, by the application delivery system 190. For example, appliance 200 may accelerate delivery of a streaming application and data file executable by the application from a data center to a remote user location by accelerating transport layer traffic between a client 102 and a server 106. Such acceleration may be provided by one or more techniques, such as 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example, via an application stream to operate in computing environment 15 on client 102, or via a remote-display protocol or otherwise via remote-based or server-based computing. In one embodiment, application delivery system 190 may be implemented as any portion of the Citrix Workspace Suite™ by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as via server-based computing, streaming or delivering the application for local execution.

For example, in operation, a client 102 may request execution of an application (e.g., application 16′) and application delivery system 190 of server 106 determines how to execute application 16′, for example, based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. The application may be any application related to real time data communications, such as applications for streaming graphics, streaming video and/or audio or other data, delivery of remote desktops or workspaces or hosted services or applications, for example, infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example, by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc.

The monitoring agents 120 and 197 may monitor, measure, collect, and/or analyze data on a predetermined frequency, based upon an occurrence of given event(s) or in real time during operation of network environment 100. The monitoring agents may monitor resource consumption and/or performance of hardware, software, and/or communications resources of clients 102, networks 104, appliances 200, and/or 205, and/or servers 106. For example, network aspects such as a transport layer protocols, latency, bandwidth utilization, end-user response times, application usage and performance, session connections to an application, cache usage, memory usage, processor usage, storage usage, database transactions, client and/or server utilization, active users, duration of user activity, application crashes, errors, or hangs, application, server or deliver system log-in durations, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, periodically or in real time, to optimize application delivery by servers 106 to clients 102, based upon network environment performance and conditions.

In described embodiments, clients 102, servers 106, and appliances 200 and 205 may be deployed as and/or executed on any type or form of computing device, such as a desktop computer, laptop computer, or mobile device capable of communicating over at least one network and performing the operations described herein. For example, clients 102, servers 106, and/or appliances 200 and 205 may each correspond to one computer, a plurality of computers, or a network of distributed computers, such as computer 101 shown in FIG. 1C.

As shown in FIG. 1C, computer 101 may include one or more of processors 103, volatile memory 122 (e.g., RAM), non-volatile memory 128 (e.g., one or more hard disk drives (HDDs) or other magnetic or optical storage media, one or more solid state drives (SSDs), such as a flash drive or other solid state storage media, one or more hybrid magnetic and solid state drives, and/or one or more virtual storage volumes, such as a cloud storage, or a combination of such physical storage volumes and virtual storage volumes, or arrays thereof), user interface (UI) 123, one or more communications interfaces 118, and communication bus 150. User interface 123 may include graphical user interface (GUI) 124 (e.g., a touchscreen, display, etc.) and one or more input/output (I/O) devices 126 (e.g., a mouse, keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106, and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital, or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine providing an execution session within which applications execute on behalf of a user or a client computing device (e.g., a client 102), such as a hosted desktop session, may execute a terminal services session to provide a hosted desktop environment, or may provide access to a computing environment including one or more of applications, desktop applications, and desktop sessions in which one or more applications may execute.

### B. Appliance Architecture

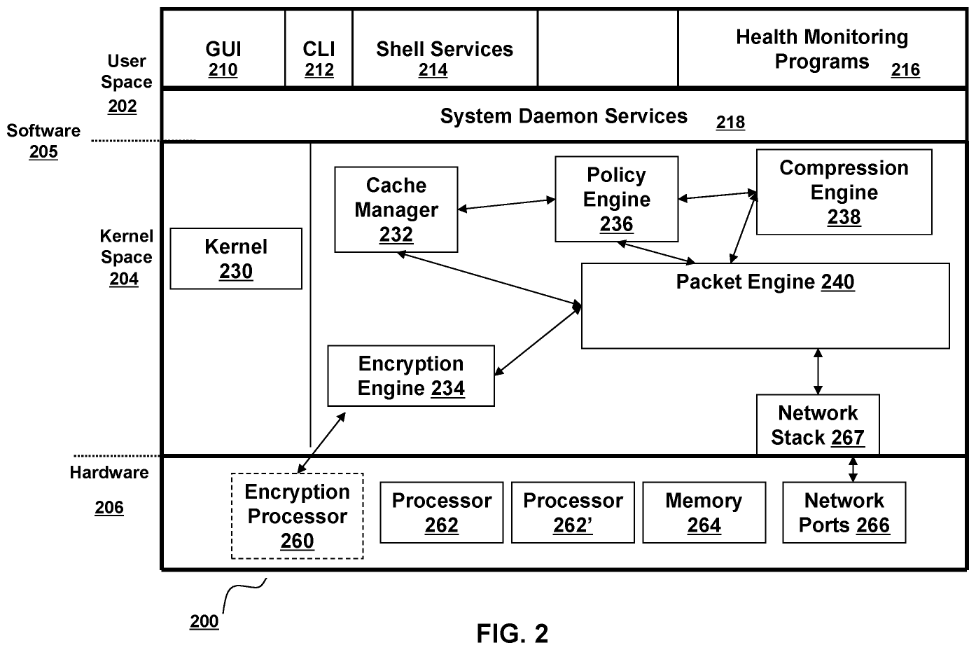

FIG. 2 shows an example embodiment of appliance 200. As described herein, appliance 200 may be implemented as a server, gateway, router, switch, bridge, or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allows programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data, such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of applications 116. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236, and compression engine 238. In other words, one or more of processes 232, 240, 234, 236, and 238 run in the core address space of the operating system of appliance 200, which may reduce the number of data transactions to and from the memory and/or context switches between kernel mode and user mode, for example, since data obtained in kernel mode may not need to be passed or copied to a user process, thread, or user level data structure.

Cache manager 232 may duplicate original data stored elsewhere or data previously computed, generated, or transmitted to reduce the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define, or configure a caching policy and access, control, and management of objects, data, or content being cached by appliance 200, and define or configure security, network traffic, network access, compression, or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS, or other secure connections, for example, between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example, to perform encryption/decryption, traffic management, such as request-level content switching and request-level cache redirection, and compression and decompression of data.

User space 202 is a memory area or portion of the operating system used by user mode applications or programs running in user mode. A user mode application may not access kernel space 204 directly and uses service calls in order to access kernel services. User space 202 may include GUI 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes, or executable instructions to support interaction with appliance 200 by a user via the GUI 210 and/or CLI 212.

Health monitor 216 checks, reports, and ensures that network systems are functioning properly and that users are receiving requested content over a network, for example, by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or the health of any portion of appliance 200. Further, health monitor 216 may determine if a program, process, service, or task is active and currently running, check status, error, or history logs provided by any program, process, service, or task to determine any condition, status, or error with any portion of appliance 200. Additionally, health monitor 216 may measure and monitor the performance of any application, program, process, service, task, or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may install and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed, or controlled by client agent 120 to, for example, intercept and redirect a transport layer connection to an IP address and a port controlled or managed by client agent 120. Thus, client agent 120 may transparently intercept any protocol layer below the transport layer, such as the network layer, and any protocol layer above the transport layer, such as the session, presentation, or application layers. Client agent 120 can interface with the transport layer to secure, optimize, accelerate, route, or load-balance any communications provided via any protocol carried by the transport layer.

In some embodiments, client agent 120 is implemented as an Independent Computing Architecture (ICA) client developed by Citrix Systems, Inc. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication, and authorization control of the client's connection to network 104. For example, client agent 120 may identify and determine one or more client-side attributes, such as the operating system and/or a version of an operating system, a service pack of the operating system, a running service, a running process, a file, presence, or version of various applications of the client, such as antivirus, firewall, security, and/or other software.

### C. Systems and Methods for Virtualizing an Application Delivery Controller

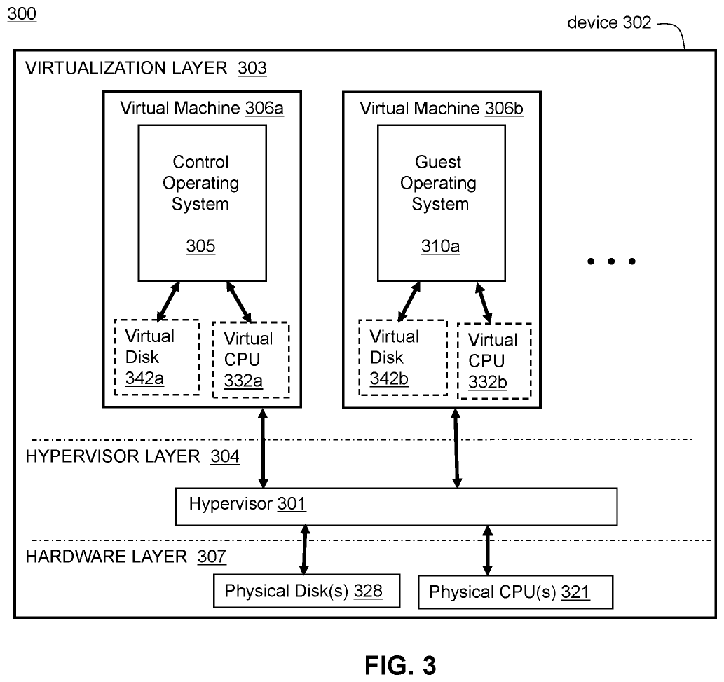

Referring now to FIG. 3, a block diagram of a virtualized environment 300 is shown. As shown, a computing device 302 in virtualized environment 300 includes a virtualization layer 303, a hypervisor layer 304, and a hardware layer 307. Hypervisor layer 304 includes one or more hypervisors (or virtualization managers) 301 that allocate and manage access to a number of physical resources in hardware layer 307 (e.g., physical processor(s) 321 and physical disk(s) 328) by at least one virtual machine (VM) (e.g., one of VMs 306) executing in virtualization layer 303. Each VM 306 may include allocated virtual resources, such as virtual processors 332 and/or virtual disks 342, as well as virtual resources, such as virtual memory and virtual network interfaces. In some embodiments, at least one of VMs 306 may include a control operating system (e.g., 305) in communication with hypervisor 301 and be used to execute applications for managing and configuring other VMs (e.g., guest operating systems 310) on device 302.

In general, hypervisor(s) 301 may provide virtual resources to an operating system of VMs 306 in any manner that simulates the operating system having access to a physical device. Thus, hypervisor(s) 301 may be used to emulate virtual hardware, partition physical hardware, virtualize physical hardware, and execute virtual machines that provide access to computing environments. In an illustrative embodiment, hypervisor(s) 301 may be implemented as a Citrix Hypervisor by Citrix Systems, Inc. In an illustrative embodiment, device 302 executing a hypervisor that creates a VM platform on which guest operating systems may execute is referred to as a host server 302.

Hypervisor 301 may create one or more VMs 306 in which an operating system (e.g., control operating system 305 and/or guest operating system 310) executes. For example, the hypervisor 301 loads a VM image to create VMs 306 to execute an operating system. Hypervisor 301 may present VMs 306 with an abstraction of hardware layer 307, and/or may control how physical capabilities of hardware layer 307 are presented to VMs 306. For example, hypervisor(s) 301 may manage a pool of resources distributed across multiple physical computing devices.

In some embodiments, one of VMs 306 (e.g., the VM executing control operating system 305) may manage and configure other of VMs 306, for example, by managing the execution and/or termination of a VM and/or managing allocation of virtual resources to a VM. In various embodiments, VMs may communicate with hypervisor(s) 301 and/or other VMs via, for example, one or more Application Programming Interfaces (APIs), shared memory, and/or other techniques.

In general, VMs 306 may provide a user of device 302 with access to resources within virtualized computing environment 300, for example, one or more programs, applications, documents, files, desktop and/or computing environments, or other resources. In some embodiments, VMs 306 may be implemented as fully virtualized VMs that are not aware that they are virtual machines (e.g., a Hardware Virtual Machine or HVM). In other embodiments, the VM may be aware that it is a virtual machine, and/or the VM may be implemented as a paravirtualized (PV) VM.

Although shown in FIG. 3 as including a single virtualized device 302, virtualized environment 300 may include a plurality of networked devices in a system in which at least one physical host executes a virtual machine. A device on which a VM executes may be referred to as a physical host and/or a host machine. For example, appliance 200 may be additionally or alternatively implemented in a virtualized environment 300 on any computing device, such as a client 102, server 106 or appliance 200. Virtual appliances may provide functionality for availability, performance, health monitoring, caching and compression, connection multiplexing and pooling, and/or security processing (e.g., firewall, VPN, encryption/decryption, etc.), similarly as described in regard to appliance 200.

In some embodiments, a server may execute multiple virtual machines 306, for example, on various cores of a multi-core processing system and/or various processors of a multiple processor device. For example, although generally shown herein as “processors” (e.g., in FIGS. 1C, 2, and 3), one or more of the processors may be implemented as either single- or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load, or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment (e.g., 300) on a client 102, server 106 or appliance 200, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example, to balance the flows across the cores. For example, packet distribution may be based upon determinations of functions performed by each core, source and destination addresses, and/or whether a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field, or payload of network packet, and include any tuples of information associated with a network packet or data flow, such as addresses and ports. The hash result or any portion thereof may be used to identify a processor, core, engine, etc., for distributing a network packet, for example, via a hash table, indirection table, or other mapping technique.

### D. Systems and Methods for Providing a Distributed Cluster Architecture

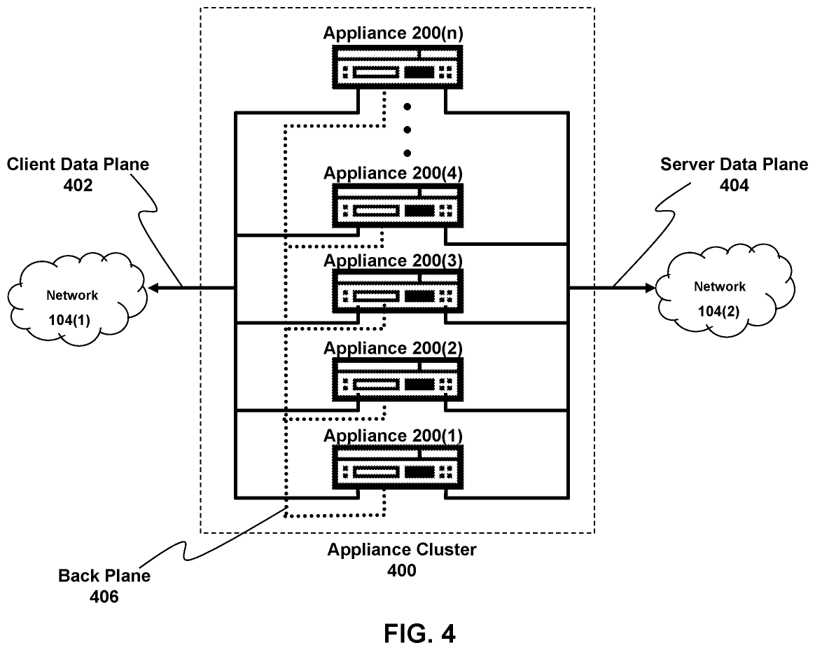

Although shown in FIGS. 1A and 1B as being single appliances, appliances 200 may be implemented as one or more distributed or clustered appliances. Individual computing devices or appliances may be referred to as nodes of the cluster. A centralized management system may perform load balancing, distribution, configuration, or other tasks to allow the nodes to operate in conjunction as a single computing system. Such a cluster may be viewed as a single virtual appliance or computing device. FIG. 4 shows a block diagram of an illustrative computing device cluster or appliance cluster 400. A plurality of appliances 200 or other computing devices (e.g., nodes) may be joined into a single cluster 400. Cluster 400 may operate as an application server, network storage server, backup service, or any other type of computing device to perform many of the functions of appliances 200 and/or 205.

In some embodiments, each appliance 200 of cluster 400 may be implemented as a multi-processor and/or multi-core appliance, as described herein. Such embodiments may employ a two-tier distribution system, with one appliance of the cluster distributing packets to nodes of the cluster, and each node distributing packets for processing to processors/cores of the node. In many embodiments, one or more of appliances 200 of cluster 400 may be physically grouped or geographically proximate to one another, such as a group of blade servers or rack mount devices in a given chassis, rack, and/or data center. In some embodiments, one or more of appliances 200 of cluster 400 may be geographically distributed, with appliances 200 not physically or geographically co-located. In such embodiments, geographically remote appliances may be joined by a dedicated network connection and/or VPN. In geographically distributed embodiments, load balancing may also account for communications latency between geographically remote appliances.

In some embodiments, cluster 400 may be considered a virtual appliance, grouped via common configuration, management, and purpose, rather than as a physical group. For example, an appliance cluster may comprise a plurality of virtual machines or processes executed by one or more servers.

As shown in FIG. 4, appliance cluster 400 may be coupled to a first network 104(1) via client data plane 402, for example, to transfer data between clients 102 and appliance cluster 400. Client data plane 402 may be implemented a switch, hub, router, or other similar network device internal or external to cluster 400 to distribute traffic across the nodes of cluster 400. For example, traffic distribution may be performed based on equal-cost multi-path (ECMP) routing with next hops configured with appliances or nodes of the cluster, open-shortest path first (OSPF), stateless hash-based traffic distribution, link aggregation (LAG) protocols, or any other type and form of flow distribution, load balancing, and routing.

Appliance cluster 400 may be coupled to a second network 104(2) via server data plane 404. Similarly to client data plane 402, server data plane 404 may be implemented as a switch, hub, router, or other network device that may be internal or external to cluster 400. In some embodiments, client data plane 402 and server data plane 404 may be merged or combined into a single device.

In some embodiments, each appliance 200 of cluster 400 may be connected via an internal communication network or back-plane 406. Back-plane 406 may enable inter-node or inter-appliance control and configuration messages, for inter-node forwarding of traffic, and/or for communicating configuration and control traffic from an administrator or user to cluster 400. In some embodiments, back-plane 406 may be a physical network, a VPN or tunnel, or a combination thereof.

### E. Systems and Methods for Domain Name System (DNS) Caching in a Distributed DNS Processing Engine

As described above, network architectures can include globally replicated cloud services to increase the availability of applications. Such cloud services can use various mechanisms to monitor the service and detect availability. The DNS selection logic can include factors based on network performance, health data, or other basic health monitoring done by the services internally, such as “pings” to identify network health status.

Moreover, networks fail to include infrastructure for an application to define its own performance factors rather than just the network performance from external sources. For example, a data intensive application may want to include performance metrics related to its CPU usage or File IO for the DNS selection logic to analyze. In another example, a distributed application that depends on several other internal services may want to include SLI (service level indicator) data that is specific to certain endpoints.

However, applications are highly dynamic and network performance alone cannot provide an accurate measurement of an application's performance or health. Therefore, global traffic routing using network performance data for these applications is not optimal.

The systems and methods described herein relate to using various types of health metrics to monitor the health of the application. For example, the health metrics can include connection metrics generated with synthetic monitoring, system health metrics like CPU usage, packet rates, memory usage, and other SLI metrics that measure the availability of the multitenant service. The systems and methods described herein describe how this continuous health monitoring can facilitate adjusting the routing selections. For example, the selection logic can prevent network outages by assigning lower precedence to relatively unhealthy servers because of their load or by removing servers until they regain their health status.

Described herein are systems and methods for computing application performance scores (also known as health scores) to route global traffic in a geographically distributed cloud service. The embodiments described herein enable cloud services to identify metrics that are important to their network instead of having to rely solely on generic network performance data. Based on the metrics, a DNS resolver can identify performance scores of the cloud service hosting the applications. The DNS resolver can use the performance scores to make global routing decisions for the network traffic bound for the cloud service. Routing decisions based on real time application performance can facilitate optimal selections of cloud services that can provide resources for the clients.

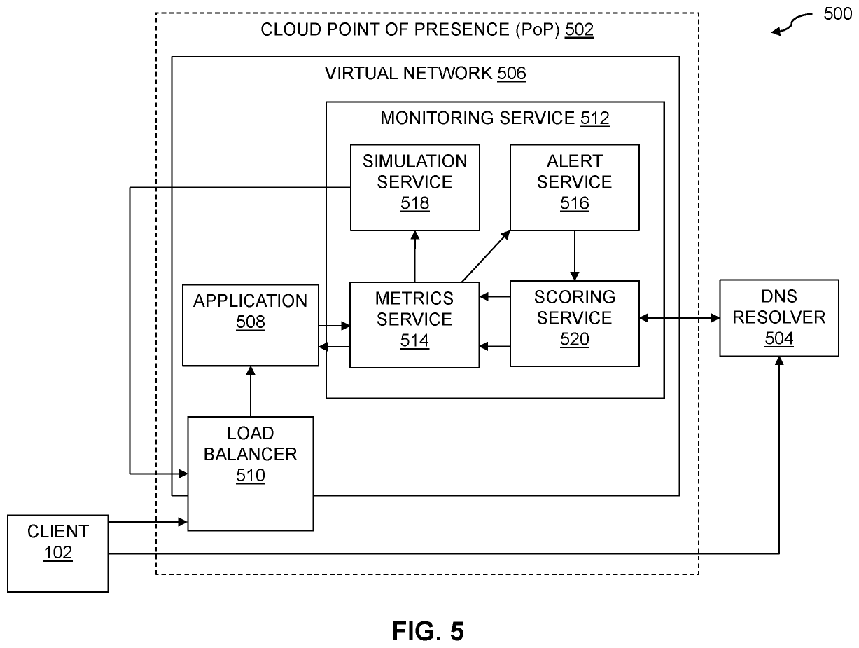

Referring now to FIG. 5, FIG. 5 is a block diagram of an environment 500 for application health based network traffic routing in a geographically distributed cloud service, in accordance with one or more embodiments. In brief overview, the environment 500 can include a client 102 and a cloud point of presence (PoP) 502 and a DNS resolver 504. The cloud point of presence 502 can further include can include a virtual network 506, which can include an application 508 (also known as a resource). The environment 500 can further includes a load balancer 510 (also known as a global load balancer). The virtual network 506 further includes a monitoring service 512, which can include a metrics service 514 (also referred to as Prometheus), an alert service 516 (also referred to as Prometheus alert manager), a simulation service 518 (also referred to as a PoP health service), and a scoring service 520 (also referred to as a PoP health service). Although FIG. 5 only shows one cloud PoP 502, it should be appreciated that the environment 500 can include any number of cloud PoPs 502 that each provides a respective virtual network 506 for hosting the application 508 and monitoring by a respective monitoring service 512.

The client 102 can be communicatively coupled to the DNS resolver 504 and the load balancer 510, which can be communicatively coupled to the application 508 and the simulation service 518. The application 508 can be communicatively coupled to the metrics service 514. The metrics service 514 can be communicatively coupled to the alert service 516, the simulation service 518, and the scoring service 520.

As described in greater detail below and as a brief overview, the client 102 can be configured to request access to the application 508 hosted by the virtual network 506 of the cloud PoP 502. To be routed to the application 508, the client 102 can be configured to transmit a DNS resolution request to the DNS resolver 504. The DNS resolver 504 can receive a performance score of the virtual network 506. Based on the performance score, the DNS resolver 504 can select a cloud PoP 502 via which to route the client 102 to the application 508. By relying on the performance score, the DNS resolver 504 can select the cloud PoP 502 based on metrics of the cloud PoP 502 itself (e.g., CPU usage) rather than generic network factors (e.g., throughput). To route the client 102, the DNS resolver 504 can include the selection in a response that is transmitted to the client 102.

The client 102, the cloud point of presence (PoP) 502 (including the virtual network 506 that can include the application 508 and the monitoring service 512 (including the metrics service 514, the alert service 516, the simulation service 518, and the scoring service 520)), the DNS resolver 504, and the load balancer 510 can be implemented using components described in connection with FIGS. 1-4. Each of the above-mentioned elements or entities is implemented in hardware, or a combination of hardware and software, in one or more embodiments. Each component of the environment 500 can be implemented using hardware or a combination of hardware or software detailed above in connection with FIGS. 1-4. In some embodiments, the appliance 200 can be a data driven global load balancer that can communicate, manage, or replicate the one or more servers 106. In some embodiments, the data file 17′ of the server 106 can be application performance metrics of an application performance metrics database. In some embodiments, the application delivery system 190 of the server 106 can be an application health score computation service. In some embodiments, the policy engine 195 of the application delivery system 190 can include health measurement rules. In some embodiments, the performance monitoring agent 197 of the server 106 can be a synthetic performance monitoring agent. Each of these elements or entities can include any application, program, library, script, task, service, process, or any type and form of executable instructions executing on hardware of the various components in the environment 500. The hardware includes circuitry such as one or more processors in one or more embodiments.

The client 102 can be any device through which an end user can access an application. The client 102 can be a device that is configured to access or log in to a secure workspace or platform, for instance, CITRIX Gateway. The client 102 can be configured to request access to the application 508 hosted by the virtual network 506 of the cloud PoP 502. To be routed to the application 508, the client 102 can be configured to transmit a DNS resolution request to the DNS resolver 504. The client 102, in response to receiving a response to the DNS resolution request from the DNS resolver 504, can access the cloud PoP 502 selected by the DNS resolver 504.

The cloud PoP 502 of the environment 500 can be configured to be a collection of cloud resources deployed to a public cloud. The cloud PoP 502 can be configured to be replicated for scalability. The cloud PoP 502 can be configured to be an intermediary, interface, or access point that includes the virtual network 506. The cloud PoP 502 can be located in a unique geographic location and/or a data center. The cloud PoPs 502 can be configured to be or include servers, routers, network switches, multiplexers, and other network interface equipment. The cloud PoP 502 can be configured to include the virtual network 506. The cloud PoP 502 can be configured to host the application 508. For example, the cloud PoP 502 can be configured to host the application 508 on the virtual network 506.

The DNS resolver 504 can be configured to receive or identify a performance score of the application 508. The DNS resolver 504 can be configured to receive, obtain, or acquire the performance score from the monitoring service 512, which can be configured to execute on the cloud PoPs 502 that host the application 508. The DNS resolver 504 can be configured to receive the performance scores in data feeds from the scoring service 520 of the monitoring service 512. The DNS resolver 504 can be configured to receive or identify additional performance scores of the application 508. The DNS resolver 504 can be configured to receive or identify the additional performance scores from additional monitoring services 512 executing on cloud PoPs 502 configured to host a copy or instance of the application 508. For example, the DNS resolver can receive a first performance score from a first monitoring service 512 executing on one or more first cloud PoPs 502 configured to host the application 508, and a second performance score from a second monitoring service 512 executing on one or more second cloud PoPs 502 configured to host the application 508. In some embodiments, the DNS resolver 504 can be configured to configure the application 508 to provide metrics to generate, receive, or identify the performance score.

The DNS resolver 504 can be configured to determine, identify, obtain or generate metrics based on the performance scores. The metrics can be associated with the one or more cloud PoPs 502 configured to host an instance or copy of the application 508. The metrics can include a round trip time corresponding to or between the DNS resolver 504 and the one or more servers of the PoPs 502. The DNS resolver 504 can be configured to compute or identify the performance score from a plurality of metrics. The DNS resolver 504 can be configured to identify or receive the metrics from the monitoring service 512 executing on the one or more cloud PoPs 502 configured to be in communication with the application 508. The plurality of metrics can include a first set of performance metrics based on simulated client requests and a second set of performance metrics based on live client requests. The performance score can be based on a first weight assigned to the first set of performance metrics and a second weight assigned to the second set of performance metrics. The plurality of metrics can include at least one fixed metric and at least one variable metric. Details relating to the fixed and variable metrics are provided below. The DNS resolver 504 can be configured to assign different weights to different types of metrics. For example, the DNS resolver 504 can be configured to assign a first weight to the at least one fixed metric and a second weight to the at least one variable metric. The DNS resolver 504 can determine, identify, or calculate the performance score based on the weights.

In addition to or in lieu of the performance score, the DNS resolver 504 can be configured to receive or identify a status of the one or more cloud PoPs 502 hosting the application 508. The status can indicate the performance of the cloud PoPs 502. For example, the status can indicate whether the cloud PoPs 502 can be configured to execute or provide the application 508. The DNS resolver 504 can be configured to receive several statuses at different times and from different servers of the cloud PoPs 502. For example, the DNS resolver 504 can be configured to receive or identify a first status of one or more first cloud PoPs 502 hosting the application 508 and subsequently receive a second status of one or more second cloud PoPs 502 hosting the application 508. For example, the first status can indicate that the cloud PoP 502 cannot provide the application 508 to the client 102, but the subsequent second status can indicate that the cloud PoP 502 can provide the application 508 to the client 102 (e.g., the CPU of the cloud PoP 502 was initially unavailable but subsequently became available after completing another task).

Based on the metrics, the DNS resolver 504 can be configured to either enable or restrict selection of the cloud PoPs 502. In some embodiments, the DNS resolver 504 can be configured to enable or restrict selection based on the status of the cloud PoPs 502. For example, the DNS resolver 504 can be configured to restrict selection of cloud PoPs 502 with a status of ‘unavailable.’ Conversely, the DNS resolver 504 can be configured to enable selection of cloud PoPs 502 with a status of ‘available.’ The DNS resolver 504 can be configured to avoid selecting restricted cloud PoPs 502, whereas the DNS resolver 504 can be configured to select enabled cloud PoPs 502. In another example, the DNS resolver 504 can be configured to de-prioritize cloud PoPs 502 that include higher RTT. In yet another example, the DNS resolver 504 can be configured to identify that the cloud PoP 502 is unable to provide the application 508 to the client 102 (e.g., unavailable bandwidth or CPU time). In some such situations, the DNS resolver 504 can be configured to exclude this cloud PoP 502 from being selected until its metrics indicate that the cloud PoP 502 is available to provide the application 508 to the client 102. Based on the DNS routing logic, the DNS resolver 504 can be configured to route the client 102 to the application 508 via at least one of the cloud PoPs 502. In some embodiments, the DNS resolver 504 can be configured to select the cloud PoP 502 based on the metrics, status, geographic location of the cloud PoP 502, DNS information, traffic performance monitoring services such as RADAR and SONAR, site reliability engineering (SRE) bias, or some combination thereof.

The DNS resolver 504 can be configured to receive or identify a request to resolve a DNS request. The DNS resolver 504 can be configured to receive the DNS request from the client 102. The DNS resolver 504 can be configured to receive the DNS request responsive to the client 102 attempting to launch or access the application 508. Responsive to the DNS request, the DNS resolver 504 can be configured to select or identify the one or more cloud PoPs 502 based on the metrics of the one or more cloud PoPs 502.

The DNS resolver 504 can be configured to manage routing of the clients 102 among the cloud PoPs 502 hosting the applications 508. The DNS resolver 504 can be configured to identify or select one or more cloud PoPs 502. The DNS resolver 504 can be configured to maintain or manage DNS domains of the cloud PoP 502 and the application 508. The DNS resolver 504 can identify or select the one or more cloud PoPs 502 responsive to the DNS request received from the client 102. The DNS resolver 504 can provide the client 102 a DNS response with the DNS domain of the cloud PoP 502 via which to access the application 508. The DNS resolver 504 can identify or select the one or more cloud PoPs 502 based on one or more performance scores of the application 508. The DNS resolver 504 can be configured to include identifiers of the selected cloud PoP 502. For example, the identifier can be a network address, a domain name, or a fully qualified domain name (FQDN). The DNS resolver 504 can be configured to select or identify a selection from the cloud PoPs 502 enabled for selection. To select the cloud PoP 502, the DNS resolver 504 can be configured to identify whether the metrics of the cloud PoP 502 indicate that the cloud PoP 502 can provide the application 508 to the client 102. For example, the DNS resolver 504 can be configured to select cloud PoPs 502 with metrics indicative of low CPU usage instead of cloud PoPs 502 with metrics indicative of high CPU usage.

The DNS resolver 504 can be configured to transmit or send a response to the request. The DNS resolver 504 can include the identity of the one or more cloud PoPs 502 selected by the DNS resolver 504. The DNS resolver 504 can be configured to transmit or send the response to the client 102 for the client 102 to access the application 508 on the selected cloud PoP 502.

The virtual network 506 of the cloud PoP 502 can be configured to maintain the application 508 and the monitoring service 512 in the cloud PoPs 502. For example, the virtual network 506 can be scalable and private network in the cloud PoP 502.

The application 508 executing in the virtual network 506 can be configured to be an instance of a resource or service accessible to the client 102. The application 508 can be configured to be replicated amongst the one or more cloud PoPs 502. The application 508 can be configured to generate metrics to provide to the monitoring service 512. The application 508 can be configured to generate the metrics in a format, such as time-series based, that is compatible with the metrics service 514. The application 508 can be configured to expose the metrics on a representational state transfer architectural style (REST) endpoint. The endpoint can be HTTP. The application 508 can be configured to expose SLI metrics.

The load balancer 510 can be an intermediary between the client 102, the application 508, and the simulation service 518. The load balancer 510 can be configured to include an API for interfacing with the client 102, the application 508, and the simulation service 518.

The monitoring service 512 of the virtual network 506 can be configured to monitor the performance of the application 508. The monitoring service 512 can be configured as a virtual machine (VM) or a deployable computing unit, such as a Kubernetes pod. The monitoring service 512 can be configured to include the metrics service 514, the alert service 516, the simulation service 518, and the scoring service 520.

The metrics service 514 can configure the application 508 as a target from which the metrics service 514 can scrape or extract metrics. The metrics service 514 can be configured to scrape based on the definitions of the metrics service 514 that define the metrics. The metrics service 514 can be configured to receive or identify the metrics via the exposed REST endpoint. The metrics service 514 can scrape or extract performance metrics based on targets for the application 508.

The metrics service 514 can be configured to aggregate metrics from various metric targets. For example, the metrics service 514 can be configured to aggregate performance of the application 508. The metrics service 514 can be configured to store or maintain metrics as time series, such as streams of timestamped values. These streams can identify a collection of the metric's observed values over time. The streams can be a counter, a gauge, or a compound type called a histogram.

The metrics service 514 can be configured to define metric identification rules to pre-compute performance related data for a given metric. The metrics service 514 can be configured to pre-compute performance data to decrease computation time during performance measurement by the simulation service 518. For example, for fixed metrics, the metrics service 514 can be configured to pre-compute the current aggregated score over the past five-minute interval. In another example, the metrics service 514 can be configured to execute:

i.e., sum(rate(metric_name[5m]))

For variable metric scores, the metrics service 514 can be configured to pre-compute the mean and the standard deviation of the metrics in addition to the current aggregated score. In another example, the metrics service 514 can be configured to execute:

avg_over_time(sum(rate(metric_name[1w])).
stddev_over_time(sum(rate(metric_name[1w])).
sum(rate(metric_name[5m]))

The metrics service 514 can be configured to define alert rules for when the alert service 516 is to trigger alerts. The alert rules can define when anomalies are detected for a given metric. For example, anomalies can include when the computed performance score for the metric exceeds the threshold fixed by the application 508. For fixed metrics, the alert expression can be:

sum(rate(metric_name[5m])>fixed_threshold)

For variable metric scores, the alert expression can include verifying or identifying if the z-score of the metric exceeds the threshold, such as two standard deviations (2σ). For example, the metrics service 514 can be configured to execute:

i.e., (sum(rate(metric_name[5m])) −
avg_over_time(sum(rate(metric_name[1w])))) /
stddev_over_time(sum(rate(metric_name[1w]))) > 2

The alert service 516 can be configured to generate or transmit alerts relating to the metrics. The alert service 516 can include rules and alerts to define how to pre-compute performance related scores to trigger alerts when the metrics satisfy thresholds. The alert service 516 can group similar alerts and transmit the alerts to entities, such as the metrics service 514 or the simulation service 518. The alert service 516 can be configured to transmit the alerts via inter-application messages such as web-hooks or other event status identifiers.

The simulation service 518 can be configured to monitor the applications 508. In some embodiments, the simulation service 518 can be configured to simulate the applications 508. The simulation service 518 can be configured to monitor the applications 508 based on a template. The simulation service 518 can include the template to define custom metrics to identify or monitor the performance or health of the application. The template file can be a YAML file that defines cloud PoP specific metadata and a list of service objects that monitored by PHS. For example, the template file can include:

PoPName: “az-us-e”
services:

name: app-xyz

metrics:
name: tcp_rtt_seconds_count
description: “TCP Round trip time”
type: synthetic
score:
   type: variable
   currentRate: job:synthetic_tcp_rtt:rate5m
   mean: job:synthetic_tcp_rtt:rate5m:avg_over_time_1w
   deviation: job:synthetic_tcp_rtt:rate5m:stddev_over_time_1w
   threshold: 2 #2σ or >95.4499 percentile
name: packet_cpu_usage_percent
description: “Packets cpu usage percentage”
type: performance
score:
   type: fixed
   currentRate: job:packet_cpu_usage_percent:rate5m
   threshold: 95 #<95 percent

The scoring service 520 can be configured to use each service object to define a list of metric objects that identify the performance of the application 508. The scoring service 520 can be configured to use each metric object to identify metric specific metadata such as metric name, metric type, and score metadata. The metric specific metadata can include a metric name that identifies the name of the application 508 whose metric was exported to the metrics service 514. The metric object can include a metric type, which can include performance, SLI, or synthetic. The performance type can identify a measurement of the underlying server performance such as packet interface rate, CPU usage, or File I/O operations rate. The SLI type can identify a service level indication of specific endpoints measured by instrumenting APIs or dependency failure rates. For example, 95% of the login endpoint requests in any five-minute interval must be serviced in less than 300 ms. The synthetic type can identify a measurement of network latency of endpoints of an application as viewed by a close proximity client. For example, the measurements can be of a TCP round trip time or TCP handshake failure rate.

The scoring service 520 can be configured to retrieve or receive metrics from the metrics service 514. The scoring service 520 can be configured to use a native query language of the metrics service 514 to receive or retrieve the metrics.

The scoring service 520 can be configured to retrieve or receive alerts from the alert service 516. The scoring service 520 can be configured to retrieve or receive the pre-computed scores from the alert service 516. The scoring service 520 can be configured to identify the pre-computed score for each metric defined for the application 508.

The scoring service 520 can be configured to calculate or identify a performance score relating to performance of the application 508. The scoring service 520 can be configured to use metadata to identify a performance score from the metric and a percentage weight of the resulting score as it relates to the performance of the application 508. The calculated score for a given metric can depict outliers or anomalies in the performance of the application 508. The score can be a percentage value between 0-100. For example, a larger value can indicate poor performance of the cloud PoP 502, such as that the CPU is 95% utilized.

Depending on the metric that is being observed, the scoring service 520 can be configured to classify the calculation of the performance score into at least a fixed metric calculation or a variable metric score calculation. For the fixed metric score calculation, the scoring service 520 can be configured to compare the current value of the fixed metric with a fixed threshold. The fixed threshold can indicate an upper or lower bound of the fixed metric. For example, the CPU usage metric can represent a percentage value of the cloud PoP's 502 CPU consumption, and an upper bound of 95% can be a threshold for the metric relating to CPU consumption. Responsive to identifying values that are close to or exceed the upper bound, the scoring service 520 can be configured to identify that the client 102 is not to be routed to this cloud PoP 502. For example, based on the values, the scoring service 520 can be configured to set a status of the cloud PoP 502. The scoring service 520 can be configured to set a status of ‘unavailable’ responsive to identifying values close to or exceeding the upper bound. The DNS resolver 504 can be configured to restrict the cloud PoP based on the status indicating that the cloud PoP 502 is ‘unavailable.’

The algorithm for fixed metric score calculation can be expressed as:

score=(f(x)/fixed_threshold_value)*100

where f(x)=sum(rate(metric_name[5m])); aggregate of fixed metric's observed values over past 5 minutes in Prometheus.

The scoring service 520 can be configured to perform variable metric score calculations can be performed when the upper or lower bounds for the variable metric does not have a fixed threshold value. For example, a metric such as a TCP Round Trip Time (RTT) might not have upper or lower bounds. In such cases, the scoring service 520 can be configured to compute or identify the z-score of the current metric value to determine its performance. Based on the z-score, the scoring service 520 can be configured to identify whether the standard deviation (σ) of the current value deviates from its weekly or monthly mean value. A z-score that is greater than 2σ can indicate that a metric value deviates by more than 95% from its mean value.

The algorithm for variable metric score calculations can be expressed as:

z-score=(f(x)−f(m))/f(d)

where f(x)=sum(rate(metric_name[5m])); aggregate of metric's observed values over past 5 minutes in Prometheus,
f(m)=avg_over_time(sum(rate(metric_name[1w]))); mean of metric's observed values over past 1 week in Prometheus,
f(m)=stddev_over_time(sum(rate(metric_name[1w]))); standard deviation of metric's observed values over past 1 week in Prometheus;
score=pnorm(z-score); percentile value of z-score

After calculating the individual scores for the metrics of the service, the scoring service 520 can be configured to compute the performance score by calculating a weighted sum of each score of each metric. The scoring service 520 can be configured to apply weights to the averaging. The scoring service 520 can be configured to apply, identify, or receive weights in the template file or from the application 508.

The scoring service 520 can be configured to calculate the performance score as follows:

final_score=x % of score1+y % of score2+ . . .

Where x+y+ . . . =100

The scoring service 520 can be configured to provide the calculated performance scores to the DNS resolver 504. The scoring service 520 can be configured to provide the calculated performance scores for the application 508. The scoring service 520 can be configured to provide the calculated performance scores responsive to a request by the client 102 to access the application 508.

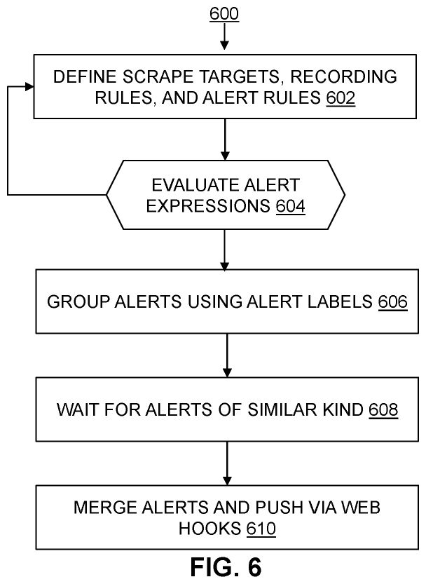

Referring now to FIG. 6, FIG. 6 is a diagram of a workflow 600 of the metrics service 514 and the alert service 516 for application health based network traffic routing in a geographically distributed cloud service, in accordance with one or more embodiments. For example, the components described in FIGS. 1-5 and/or the metrics service 514 and the alert service 516 detailed above can perform the operations and functionalities of the workflow 600. In brief overview, the metrics service 514 can define scrape targets, recording rules, and alert rules (STEP 602). The metrics service 514 can evaluate alert expressions (STEP 604). The alert service 516 can group alerts using alert labels (STEP 606). The alert service 516 can wait for alerts of similar kind (STEP 608). The alert service 516 can merge alerts and push via web hooks (STEP 610).

The metrics service 514 can define scrape targets, recording rules, and alert rules (STEP 602). The metrics service 514 can configure the application 508 as a target from which the metrics service 514 can scrape or extract metrics. The metrics service 514 can scrape based on the definitions of the metrics service 514 that define the metrics. The metrics service 514 can receive or identify the metrics via the exposed REST endpoint. The metrics service 514 can scrape or extract performance metrics based on targets for the application 508.

The metrics service 514 can aggregate metrics from various metric targets. For example, the metrics service 514 can aggregate performance of the application 508. The metrics service 514 can store or maintain metrics as time series such as streams of timestamped values. These streams can identify a collection of the metric's observed values over time. The streams can be a counter, a gauge, or a compound type called histogram.

The metrics service 514 can define metric identification rules to pre-compute performance related data for a given metric. The metrics service 514 can pre-compute performance data to decrease computation time during performance measurement by the simulation service 518. For example, for fixed metric scores, the metrics service 514 can pre-compute the current aggregated score over the past five-minute interval.

The metrics service 514 can evaluate alert expressions (STEP 604). The metrics service 514 can define alert rules for when the alert service 516 is to trigger alerts. The alert rules can define when anomalies are detected for a given metric. For example, the metrics service 514 can define anomalies that include when the computed performance score for the metric exceeds the threshold fixed by the application 508. For fixed metric scores, the alert service 516 can define a threshold (e.g., lower bound or upper bound). For variable metric scores, the alert expression can include verifying or identifying if the z-score of the metric exceeds the threshold, such as two standard deviations (2σ).

The alert service 516 can group alerts using alert labels (STEP 606). The alert service 516 can group similar alerts. The alert service 516 can assign labels to similar alerts. The alert service 516 can wait for alerts of similar kind (STEP 608). The alert service 516 can wait for a predetermined time based on the rules set by the metrics service 514.

The alert service 516 can merge alerts and push via web hooks (STEP 610). The alert service 516 can transmit the alerts to entities such as the metrics service 514 or the simulation service 518. The alert service 516 can transmit the alerts via inter-application messages such as web-hooks or other event status identifiers.

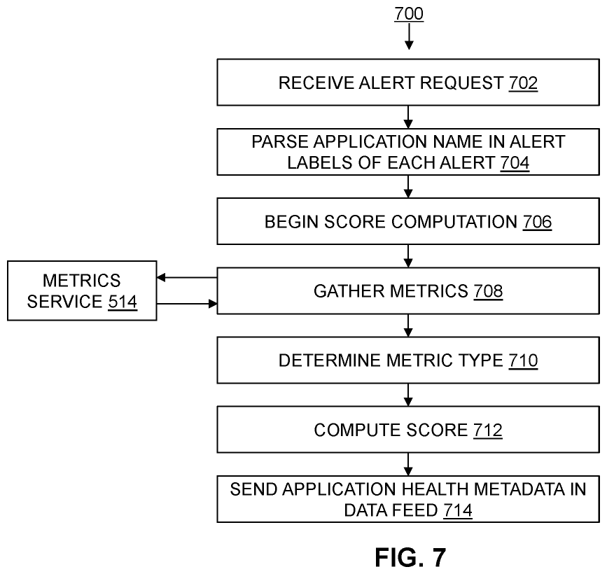

Referring now to FIG. 7, FIG. 7 is a diagram of a workflow 700 of the simulation service 518 and the scoring service 520 for application health based network traffic routing in a geographically distributed cloud service, in accordance with one or more embodiments. For example, the components described in FIGS. 1-5 and/or the scoring service 520 detailed above can perform the operations and functionalities of the workflow 700. In brief overview, the scoring service 520 can receive an alert request (STEP 702). The scoring service 520 can parse application name in alert labels of each alert (STEP 704). The scoring service 520 can begin score computation (STEP 706). The scoring service 520 can gather metrics (STEP 708). The scoring service 520 can determine a metric type (STEP 710). The scoring service 520 can compute a score (STEP 712). The scoring service 520 can send the scores to the DNS resolver 504 as application health metadata in a data feed for data driven global load balancers (e.g., the load balancer 510) (STEP 714).

The scoring service 520 can receive an alert request (STEP 702). The alert rules can define when anomalies (e.g., high CPU utilization) are detected for a given metric. The scoring service 520 can retrieve or receive alerts from the alert service 516. The scoring service 520 can retrieve or receive the pre-computed scores from the alert service 516. The scoring service 520 can identify the pre-computed score for each metric defined for the application 508.

The scoring service 520 can parse application name in alert labels of each alert (STEP 704). By parsing the alerts, the scoring service 520 can identify the application 508 associated with the alert. The scoring service 520 can use each metric object to identify metric specific metadata indicative of metric name that identifies the name of the application 508 whose metric was exported to the metrics service 514.

The scoring service 520 can begin score computation (STEP 706). The scoring service 520 can retrieve or receive metrics from the metrics service 514. The scoring service 520 can use a native query language of the metrics service 514 to receive or retrieve the metrics. The scoring service 520 can retrieve or receive alerts from the alert service 516. The scoring service 520 can retrieve or receive the pre-computed scores from the alert service 516. The scoring service 520 can identify the pre-computed score for each metric defined for the application 508.

The scoring service 520 can gather metrics (STEP 708). The scoring service 520 can use each service object to define a list of metric objects that identify the performance of the application 508. The scoring service 520 can be configured to retrieve or receive metrics from the metrics service 514. The scoring service 520 can be configured to use a native query language of the metrics service 514 to receive or retrieve the metrics.

The scoring service 520 can determine a metric type (STEP 710). The metric object can include a metric type, which can include performance, SLI, or synthetic. Based on the performance type, the scoring service 520 can identify a measurement of the underlying server performance, such as packet interface rate, CPU usage, or File I/O operations rate. Based on the SLI type, the scoring service 520 can identify a service level indication of specific endpoints measured by instrumenting APIs or dependency failure rates. For example, 95% of the login endpoint requests in any five-minute interval must be serviced in less than 300 ms. Based on the synthetic type, the scoring service 520 can identify a measurement of network latency of endpoints of an application as viewed by a close proximity client. For example, the measurements can be of a TCP round trip time or TCP handshake failure rate.

The scoring service 520 can compute a score (STEP 712). The scoring service 520 can calculate or identify a performance score relating to performance of the application 508. The scoring service 520 can use metadata to identify a performance score from the metric and a percentage weight of the resulting score as it relates to the performance of the application 508. The scoring service 520 can use the calculated score for a given metric to depict outliers or anomalies in the performance of the application 508. The score can be a percentage value between 0-100. For example, a larger value can indicate poor performance of the cloud PoP 502, such as that the CPU is 95% utilized.

The scoring service 520 can send application health metadata in a data feed (STEP 714). The application health metadata can include the calculated performance scores. The scoring service 520 can provide the calculated performance scores to the DNS resolver 504. The scoring service 520 can provide the calculated performance scores for the application 508. The scoring service 520 can provide the calculated performance scores responsive to a request by the client 102 to access the application 508.

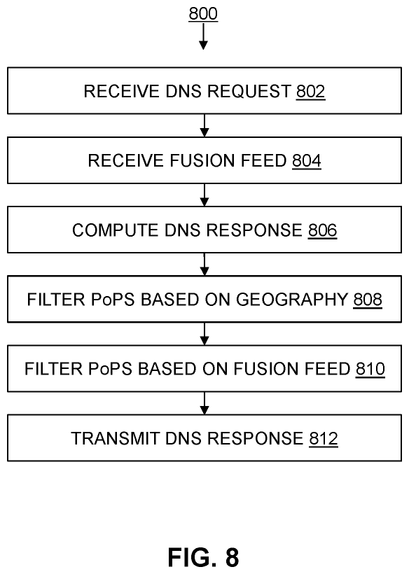

Referring now to FIG. 8, FIG. 8 is a diagram of a workflow 800 of a DNS resolver for application health based network traffic routing in a geographically distributed cloud service, in accordance with one or more embodiments. For example, the components described in FIGS. 1-5 and/or the DNS resolver 504 detailed above can perform the operations and functionalities of the workflow 800. In brief overview, the DNS resolver 504 can receive a DNS request (STEP 802). The DNS resolver 504 can receive the data feed (STEP 804). The DNS resolver 504 can compute a DNS response (STEP 806). The DNS resolver 504 can filter PoPs based on geography (STEP 808). The DNS resolver 504 can filter PoPs based on the data feed (STEP 810). The DNS resolver 504 can transmit a DNS response (STEP 812).

The DNS resolver 504 can receive a DNS request (STEP 802). The DNS resolver 504 can receive the DNS request from the client 102 to access the application 508. The DNS resolver 504 can use an API to interface with the client 102, the application 508, and the simulation service 518. The DNS resolver 504 maintains or manages DNS domains of the application 508.

The DNS resolver 504 can receive the data feed (STEP 804). The DNS resolver 504 can receive performance scores of the applications 508. The DNS resolver 504 can receive the performance scores via data feeds (also known as fusion feeds) provided or sent by the scoring service 520.

The DNS resolver 504 can compute a DNS response (STEP 806). Based on the performance scores, the DNS resolver 504 can route the client 102 to the application 508. The loud balancer can route the client 102 via at least one of the cloud PoPs 502. The DNS resolver 504 can select from the cloud PoPs 502 that host the application 508.

The DNS resolver 504 can filter cloud PoPs 502 based on geography (STEP 808). The DNS resolver 504 can select the cloud PoPs 502 that are in a certain location or geographic region. For example, the DNS resolver 504 can select the cloud PoPs 502 that are close to the location of the client 102.

The DNS resolver 504 can filter PoPs based on the data feed (STEP 810). The DNS resolver 504 can select the cloud PoPs 502 based on the performance scores included in the data feed. For example, the DNS resolver 504 can select the cloud PoPs 502 that have low CPU utilization rates.

The DNS resolver 504 can transmit a DNS response (STEP 812). The DNS resolver 504 can include identifiers of the selected cloud PoP 502 in the DNS response. For example, the identifier can be a network address, a domain name, or a fully qualified domain name (FQDN) that resolves to the network address (e.g., IP address) of the load balancer 510 that can provide the application 508. The DNS resolver 504 can transmit or send the DNS response to the client 102 for the client 102 to access the application 508 on the selected cloud PoP 502. For example, the client 102 can use the FQDN included in the DNS response to resolve the network address (e.g., IP address) of the load balancer 510 that can be configured to route the client 102 to the cloud PoP 502 that can be configured to provide the application 508 to the client 102.

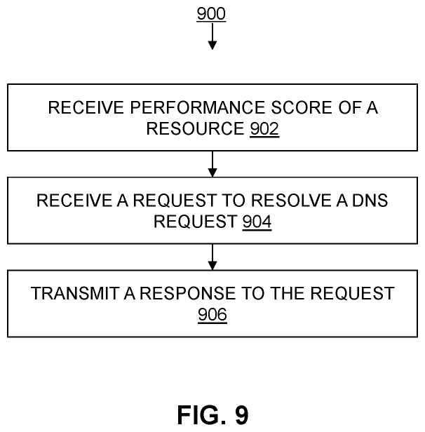

Referring now to FIG. 9, FIG. 9 depicts a diagram of a method 900 for data linkage and entity resolution of continuous and un-synchronized data streams, in accordance with one or more embodiments. The components described in FIGS. 1-6 and/or the DNS resolver 504 detailed above can perform the operations and functionalities of the method 900. In brief overview, the DNS resolver (e.g., DNS resolver 504) can receive a performance score of a resource (e.g., application 508) (STEP 902). The DNS resolver can receive a request to resolve a DNS request (STEP 904). The DNS resolver can transmit a response to the request (STEP 906).

In further detail, the DNS resolver can receive a performance score of a resource (STEP 902). The DNS resolver can receive or acquire the performance score from a service (e.g., monitoring service 512) executing on one or more servers (e.g., cloud PoPs 502) hosting the resource. The DNS resolver can receive additional performance scores of the resource. The DNS resolver can receive the additional performance scores from additional services executing additional servers that each host a copy of the resource. For example, the DNS resolver can receive a first performance score from a first service executing on one or more first servers hosting the resource, and a second performance score from a second service executing on one or more second servers hosting the resource. In some embodiments, the DNS resolver can configure the resource to provide metrics to generate, receive, or identify the performance score.

The DNS resolver can determine, identify, or generate metrics based on the performance scores. The DNS resolver can identify metrics of the one or more servers hosting the resources. For example, DNS resolver can identify a first set of metrics for a first server, and a second set of metrics for a second server. The metrics can include a round trip time corresponding to or between the DNS resolver and the one or more servers. The performance score can be computed from a plurality of metrics determined or received from a performance monitoring service (e.g., monitoring service 512) executing on the one or more servers in communication with the resource. The plurality of metrics can include a first set of performance metrics based on simulated client requests and a second set of performance metrics based on live client requests. The performance score can be based on a first weight assigned to the first set of performance metrics and a second weight assigned to the second set of performance metrics. The plurality of metrics can include at least one fixed metric and at least one variable metric. In some embodiments, the performance score is based on a first weight assigned to the at least one fixed metric and a second weight assigned to the at least one variable metric.

In addition to or in lieu of the performance score, the DNS resolver can receive or identify a status of the one or more servers hosting the resource. The status can indicate the performance of the servers. For example, the status can indicate whether the servers can execute the resource. The DNS resolver can receive several statuses at different times and from different servers. For example, the DNS resolver can receive a first status of one or more first servers hosting the resource and subsequently receive a second status of one or more second servers hosting the resource. For example, the first status can indicate that the server cannot provide the resource to the client, but the subsequent second status can indicate that the server can provide the resource to the client (e.g., the CPU of the server was initially unavailable but subsequently became available after completing another task).

The DNS resolver can receive a request to resolve a DNS request (STEP 904). The DNS resolver can receive the request from a client (e.g., client 102). Based on the metrics, the DNS resolver can either enable or restrict selection of the servers. In some embodiments, the DNS resolver can enable or restrict selection based on the status of the servers. For example, the DNS resolver can restrict selection of servers with a status of ‘unavailable.’ Conversely, the DNS resolver can enable selection of servers with a status of ‘available.’ The DNS resolver 504 can be configured to avoid selecting restricted servers, whereas the DNS resolver can select enabled servers.

The DNS resolver can select the one or more servers based on the metrics of the one or more servers. For example, the DNS resolver can select from the servers that are enabled for selection. To select the server, the DNS resolver can identify whether the metrics of the server indicate that the server can provide the resource to the client. For example, the DNS resolver can select servers with metrics indicative of low CPU usage instead of servers with metrics indicative of high CPU usage.

The DNS resolver can transmit a response to the request (STEP 906). The DNS resolver can generate the response to the request. The response can include the identified one or more servers selected by the DNS resolver based on one or more performance scores of the resource. The DNS resolver can include identifiers of the selected servers. The DNS resolver can transmit the response to the client for the client to access the resource via the selected server.

In view of the foregoing, it should be appreciated that the systems and methods described herein can provide various technical improvements. In particular, one technical improvement provided by the present disclosure can include use of a time-series database to combine metrics from component health as well as synthetics agents within each PoP on which a service executes.

Another technical improvement provided by the present disclosure includes implementing a declarative configuration of the service that pushes fusion metrics to ITM or DNS services, which makes the present disclosure compatible with modern Cl/CD deployment models.

Another technical improvement provided by the present disclosure includes routing based on calculated health scores of the specific application rather than just network performance of external sources.

Another technical improvement provided by the present disclosure includes compatibility with monitoring any cloud service application to generate intelligent routing decisions based on real time application performance.

### F. Example Embodiments

The following examples pertain to further example embodiments, from which permutations and configurations will be apparent.

Example 1 includes a method. The method includes receiving, by a domain name system (DNS) resolver from a service executing on one or more servers hosting a resource, a performance score of the resource. The method includes receiving, by the DNS resolver, from a client, a request to resolve a DNS request. The method includes transmitting, by the DNS resolver, a response to the request identifying the one or more servers selected based on the performance score of the resource.

Example 2 includes the subject matter of Example 1, wherein the performance score is computed from a plurality of metrics determined from a performance monitoring service executing on the one or more servers in communication with the resource.

Example 3 includes the subject matter of any of Examples 1 and 2, wherein the plurality of metrics comprise a first set of performance metrics based on simulated client requests and a second set of performance metrics based on live client requests.

Example 4 includes the subject matter of any of Examples 1 through 3, wherein the performance score is based on a first weight assigned to the first set of performance metrics and a second weight assigned to the second set of performance metrics.

Example 5 includes the subject matter of any of Examples 1 through 4, wherein the plurality of metrics comprise at least one fixed metric and at least one variable metric. In some embodiments, the performance score is based on a first weight assigned to the at least one fixed metric and a second weight assigned to the at least one variable metric.

Example 6 includes the subject matter of any of Examples 1 through 5, further comprising determining, by the DNS resolver, a metric of the one or more servers based on the health score. In some embodiments, the method further comprises selecting, by the DNS resolver, the one or more servers based on the determined metric.

Example 7 includes the subject matter of any of Examples 1 through 6, wherein the metric comprises a round trip time corresponding to the DNS resolver and the one or more servers.

Example 8 includes the subject matter of any of Examples 1 through 7, wherein the one or more servers are one or more first servers. In some embodiments, the method further comprises receiving, by the DNS resolver, a status of one or more second servers hosting the resource. In some embodiments, the method further comprises restricting, by the DNS resolver, selection of the one or more second servers based on the status of the one or more second servers.

Example 9 includes the subject matter of any of Examples 1 through 8, wherein the status is a first status. In some embodiments, the method further comprises receiving, by the DNS resolver, subsequent to the first status, a second status of one or more second servers hosting the resource. In some embodiments, the method further comprises enabling, by the DNS resolver, selection of the one or more second servers based on the second status of the one or more second servers.

Example 10 includes the subject matter of any of Examples 1 through 9, wherein the service is a first service, the one or more servers is one or more first servers and the performance score is a first performance score. In some embodiments, the method further comprises receiving, by the domain name system (DNS) resolver from a second service executing on one or more second servers hosting the resource, a second health score of the resource. In some embodiments, transmitting, by the DNS resolver, the response to the request identifying the one or more servers includes transmitting, by the DNS resolver, the response to the request identifying the one or more first servers selected based on the first health score of the resource and the second health score of the resource.

Example 11 includes the subject matter of any of Examples 1 through 10, further comprising configuring the resource to provide metrics used by the health service to generate the health score.

Example 12 includes a system. The system includes a domain name system (DNS) resolver. The DNS resolver is configured to receive, from a service executing on one or more servers hosting a resource, a performance score of the resource. The DNS resolver is configured to receive, from a client, a request to resolve a DNS request. The DNS resolver is configured to transmit a response to the request identifying the one or more servers selected based on the performance score of the resource.

Example 13 includes the subject matter of Example 12, wherein the performance score is computed from a plurality of metrics determined from a performance monitoring service executing on the one or more servers in communication with the resource.

Example 14 includes the subject matter of any of Examples 12 and 13, wherein the plurality of metrics comprise a first set of performance metrics based on simulated client requests and a second set of performance metrics based on live client requests.

Example 15 includes the subject matter of any of Examples 12 through 14, wherein the performance score is based on a first weight assigned to the first set of performance metrics and a second weight assigned to the second set of performance metrics.

Example 16 includes the subject matter of any of Examples 12 through 15, wherein the plurality of metrics comprise at least one fixed metric and at least one variable metric. In some embodiments, the performance score is based on a first weight assigned to the at least one fixed metric and a second weight assigned to the at least one variable metric.

Example 17 includes the subject matter of any of Examples 12 through 16, wherein the DNS resolver is further configured to determine a metric of the one or more servers based on the health score. In some embodiments, the DNS resolver is further configured to select the one or more servers based on the determined metric.

Example 18 includes the subject matter of any of Examples 12 through 17, wherein the metric comprises a round trip time corresponding to the DNS resolver and the one or more servers.

Example 19 includes the subject matter of any of Examples 12 through 18, wherein the one or more servers are one or more first servers. In some embodiments, the DNS resolver is further configured to receive a status of one or more second servers hosting the resource. In some embodiments, the DNS resolver is further configured to restrict selection of the one or more second servers based on the status of the one or more second servers.

Example 20 includes the subject matter of any of Examples 12 through 19, wherein the status is a first status. In some embodiments, the DNS resolver is further configured to receive, subsequent to the first status, a second status of one or more second servers hosting the resource. In some embodiments, the DNS resolver is further configured to enable selection of the one or more second servers based on the second status of the one or more second servers.

Example 21 includes the subject matter of any of Examples 12 through 20, wherein the service is a first service, the one or more servers is one or more first servers and the performance score is a first performance score. In some embodiments, the DNS resolver is further configured to receive, from a second service executing on one or more second servers hosting the resource, a second health score of the resource. In some embodiments, transmitting the response to the request identifying the one or more servers includes transmitting the response to the request identifying the one or more first servers selected based on the first health score of the resource and the second health score of the resource.

Example 22 includes a non-transitory computer readable medium storing program instructions that, when executed by one or more processors, cause the one or more processors to receive, from a service executing on one or more servers hosting a resource, a performance score of the resource. The one or more processors can receive, from a client, a request to resolve a domain name system (DNS) request. The one or more processors can transmit a response to the request identifying the one or more servers selected based on the performance score of the resource.

Various elements, which are described herein in the context of one or more embodiments, may be provided separately or in any suitable sub-combination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

1. A method comprising:
receiving, by a domain name system (DNS) resolver server from a service executing on one or more servers hosting a resource, a performance score of the resource;
receiving, by the DNS resolver server, from a client, a request to resolve a DNS request;
selecting, by the DNS resolver server, a server of the one or more servers to identify in a response to the DNS request, based on the performance score of the resource hosted on the server; and
transmitting, by the DNS resolver server to the client, the response to the request identifying the server.

2. The method of claim 1, wherein the performance score is computed from a plurality of metrics determined from a performance monitoring service executing on the one or more servers in communication with the resource.

3. The method of claim 2, wherein the plurality of metrics comprise a first set of performance metrics based on simulated client requests and a second set of performance metrics based on live client requests.

4. The method of claim 3, wherein the performance score is based on a first weight assigned to the first set of performance metrics and a second weight assigned to the second set of performance metrics.

5. The method of claim 2, wherein the plurality of metrics comprise at least one fixed metric and at least one variable metric, and wherein the performance score is based on a first weight assigned to the at least one fixed metric and a second weight assigned to the at least one variable metric.

6. The method of claim 1, further comprising:
determining, by the DNS resolver server, a metric of the one or more servers based on the performance score; and
selecting, by the DNS resolver server, the one or more servers based on the determined metric.

7. The method of claim 6, wherein the metric comprises a round trip time corresponding to the DNS resolver server and the one or more servers.

8. The method of claim 1, wherein the one or more servers are one or more first servers, the method further comprising:
receiving, by the DNS resolver server, a status of one or more second servers hosting the resource; and
restricting, by the DNS resolver server, selection of the one or more second servers based on the status of the one or more second servers.

9. The method of claim 8, wherein the status is a first status, and the method further comprising:
receiving, by the DNS resolver server, subsequent to the first status, a second status of one or more second servers hosting the resource; and
enabling, by the DNS resolver server, selection of the one or more second servers based on the second status of the one or more second servers.

10. The method of claim 1, wherein the service is a first service, the one or more servers is one or more first servers and the performance score is a first performance score, the method comprising:
receiving, by the domain name system (DNS) resolver server from a second service executing on one or more second servers hosting the resource, a second performance score of the resource; and
wherein transmitting, by the DNS resolver server, the response to the request identifying the one or more servers includes transmitting, by the DNS resolver server, the response to the request identifying the one or more first servers selected based on the first performance score of the resource and the second performance score of the resource.

11. The method of claim 1, further comprising configuring the resource to provide metrics used to generate the performance score.

12. A system comprising:
a domain name system (DNS) resolver server configured to:
receive, from a service executing on one or more servers hosting a resource, a performance score of the resource;
receive, from a client, a request to resolve a DNS request;
select a server of the one or more servers to identify in a response to the DNS request, based on the performance score of the resource hosted on the server; and
transmit, to the client, a response to the request identifying the server.

13. The system of claim 12, wherein the performance score is computed from a plurality of metrics determined from a performance monitoring service executing on the one or more servers in communication with the resource.

14. The system of claim 13, wherein the plurality of metrics comprise a first set of performance metrics based on simulated client requests and a second set of performance metrics based on live client requests.

15. The system of claim 14, wherein the performance score is based on a first weight assigned to the first set of performance metrics and a second weight assigned to the second set of performance metrics.

16. The system of claim 13, wherein the plurality of metrics comprise at least one fixed metric and at least one variable metric, and wherein the performance score is based on a first weight assigned to the at least one fixed metric and a second weight assigned to the at least one variable metric.

17. The system of claim 12, wherein the DNS resolver server is further configured to:
determine a metric of the one or more servers based on the performance score; and
select the one or more servers based on the determined metric.

18. The system of claim 17, wherein the metric comprises a round trip time corresponding to the DNS resolver server and the one or more servers.

19. The system of claim 12, wherein the one or more servers are one or more first servers, and wherein the DNS resolver server is further configured to:
receive a status of one or more second servers hosting the resource; and
restrict selection of the one or more second servers based on the status of the one or more second servers.

20. The system of claim 19, wherein the status is a first status, and wherein the DNS resolver server is further configured to:
receive, subsequent to the first status, a second status of one or more second servers hosting the resource; and
enable selection of the one or more second servers based on the second status of the one or more second servers.

21. The system of claim 12, wherein the service is a first service, the one or more servers is one or more first servers and the performance score is a first performance score, and wherein the DNS resolver server is further configured to:
receive, from a second service executing on one or more second servers hosting the resource, a second performance score of the resource; and
wherein transmitting the response to the request identifying the one or more servers includes transmitting the response to the request identifying the one or more first servers selected based on the first performance score of the resource and the second performance score of the resource.

22. A non-transitory computer-readable medium storing instructions that, when executed by one or more processors, cause the one or more processors to
receive, from a service executing on one or more servers hosting a resource, a performance score of the resource;
receive, from a client, a request to resolve a domain name system (DNS) request;
select a server of the one or more servers to identify in a response to the DNS request, based on the performance score of the resource hosted on the server; and
transmit a response to the request identifying the server.
